(19) United States
(12) Patent Application Publication
(10) Pub. No.: US 2008/0230133 A1
(43) Pub. Date: Sep. 25, 2008

(54) Compressed Air System Servicing Device

(76) Inventor: Jens Garner, Stuttgart (DE)

Correspondence Address: Hoffmann & Baron, LLP, 6900 Jericho Turnpike, Syosset, NY, 11791, US

(21) Appl. No.: 10/586,008

(22) PCT Filed: Jan. 14, 2005
(86) PCT No.: PCT/EP2005/000298

§ 371 Date: Jul. 12, 2006

(30) Foreign Application Priority Data
Feb. 6, 2004 (DE) 10 2004 005 982.9

(51) Int. Cl. F15B 21/04; F15B 13/00

(52) U.S. Cl. 137/884

(57) ABSTRACT

A compressed air system servicing device consists of a plurality of functional modules, adapted to be placed in a row, of which at least one part is able to be modularly configured. These functional modules respectively comprise a uniform basic pneumatic block (10), which on two parallel outer walls (11) possesses connection means (12) for the production of pneumatic connections on placing them in line. At least two of the remaining outer wall of the basic pneumatic block (10) possess interfaces for connection with functional blocks (13, 16, 20 and 21), at least one of the interfaces being designed to cooperate with different functional blocks. Accordingly using a relatively small number of block elements functional modules may be configured in any desired manner in various different way so that production and stock holding costs may be substantially reduced.

The invention relates to a compressed air system servicing device comprising several functional modules able to be connected together in a row.

In the case of such a compressed air system servicing device disclosed in the German patent publication 19,746,179 C2 the individual functional modules are mechanically joined together, the compressed air being directly passed from module to module through the juxtaposed delimiting face and the electrical connection being by way of a bus bar integrated in a holding rail for the individual modules. Such functional modules or, respectively, servicing modules for conditioning compressed air are for example switching on valves, pressure regulators, filters, filter regulators, flow rate meters, distributors, adapters, control modules, monitoring modules and the like. Each of these modules is individually configured in a known manner, a large number of differently configured designs having to be made available to meet individual customer requirements. Simply as regards the large number of the possibilities in electrical communication and using different buses it is necessary for many different designs to be evolved, manufactured and held in stock.

Accordingly one object of the present invention is to be able to employ the individual functional modules with a smaller number of basic designs thereof to nevertheless achieve the desired degree of variation.

In accordance with the invention this aim is to be attained by an arrangement such that the modularly configured functional modules each include a uniform basic pneumatic block, which at two parallel outer walls possesses connection means for the production of the pneumatic connections on being placed in a row or in-line and that at least two of the remaining outer walls of the basic pneumatic block possess interfaces for connection with functional blocks, at least one of the interfaces being designed to accept different functional blocks.

The advantages of the invention reside more particularly in that by a combination of the uniform basic pneumatic blocks with different peripheral blocks a plurality of different functional modules may be combined together. The multiple applicability of the functional blocks in connection with basic pneumatic blocks leads to an optimization of the development and logic costs. On site for example functional blocks may be interchanged or basic pneumatic blocks may be supplemented by the addition of functional blocks so that on site adaptation to the respective use environment may be undertaken. Using relatively few different basic designs of functional blocks uniform basic pneumatic blocks may be configured to produce extremely different forms of functional modules.

The features defined in the dependent claims render possible advantageous furthermore developments and improvements in the compressed air system servicing device recited in claim 1:

In the case of the interfaces it is preferably a question of electrical and/or pneumatic connecting means, more particularly plug connecting means which ensure a rapid and simple assembly, for example by insertion or snapping into position.

It is an advantage for one of the functional blocks to be in the form of an electrical concatenation block servicing for the electrical longitudinal concatenation of a plurality of functional modules. This concatenation block may be designed for user-customized concatenation and will have either individual settings or a field bus system desired by the user.

The concatenation block will preferably comprise, on at least one side not engaging the basic pneumatic block, an electrical interface for the electrical connection with a functional block engaging the basic pneumatic block, the interface being more especially designed as an electrical plug or an electrical plug socket. On installing such a functional block then simultaneously the pneumatic connections for the basic pneumatic block and the electrical connections for the concatenation block are produced. In this respect it is expedient for the at least one functional block to overlap the basic pneumatic block and the concatenation block.

It is also an advantage for a front block to be provided which is able to be installed on the front side, facing away from the concatenation block, of the basic pneumatic block, such front block being electrically connected with the concatenation block by way of the basic pneumatic block or a functional block connected therewith. The front block is in this case preferably provided with a display device and/or an operating element.

The concatenation block may preferably comprise electrical and/or mechanical decoding means for the recognition of the respectively connected functional blocks and furthermore the concatenation block may include, in accordance with one form of the invention, an electronic control and/or diagnostic means and/or visualizing means for process parameters and process stages and may also be provided with a field bus interface. The control and/or diagnostic means may support functions of the entire compressed air system servicing device or only of one or more functional modules.

The concatenation block may be a single piece structure or consist of a conductor support element and a electronic block able to be coupled to same. The conductor support element forms in this case, together with the conductor support elements of the other functional modules, a conductor strand extending along the compressed air system servicing device, on which strand the electronic blocks are able to be arranged, for example by plugging or by clamping.

The concatenation block preferably possesses at least one printed circuit board, which is able to be connected electrically with printed circuit boards in functional blocks able to be coupled therein, and more particularly able to be plugged together.

For a variable or adjustable configuration of the functional modules or, respectively, of the compressed air system servicing device filter blocks and/or pressure regulating blocks and/or valve blocks and/or oiler blocks and/or sensor blocks and/or drier blocks and/or distributor blocks are provided as functional blocks able to be connected selectively with the basic pneumatic block.

Working examples of the invention are illustrated in the drawings and will be explained in detail in the following description.

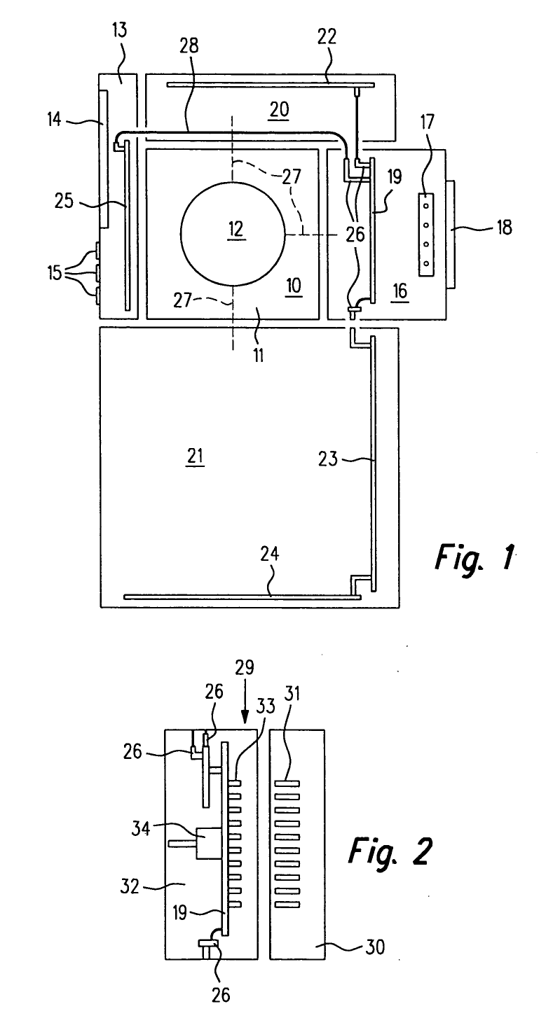

FIG. 1 shows a side view, which is in part open, of a functional module comprising a basic pneumatic block and four functional blocks connected with it, of which one is designed in the form of a single piece concatenation block.

FIG. 2 shows a two piece design of the concatenation block.

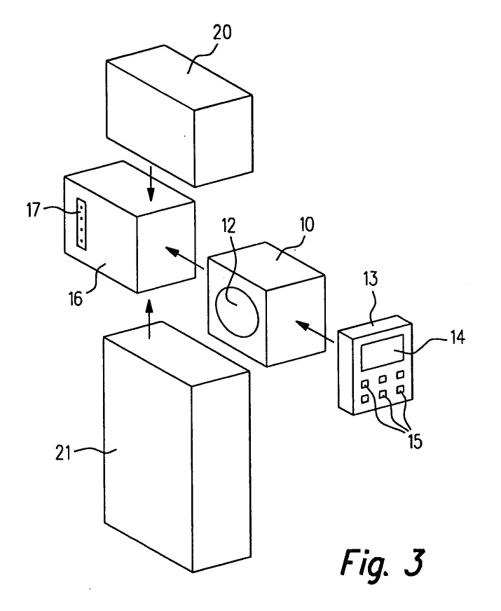

FIG. 3 is an exploded view of the blocks depicted in FIG. 1.

The functional module illustrated in FIGS. 1 and 3 is able to be placed in a row with other functional modules, the totality or sum of the functional modules placed in a row constituting a compressed air system servicing device, as represented and described in the initially mentioned prior art. The functional module represented here as a working example is modular in design. It consists of a basic pneumatic block 10, the basic pneumatic blocks of all functional modules being identical in structure at least as regards the basic interfaces. In the two terminal functional modules slight modifications may be present. The basic pneumatic block 10 possesses pneumatic interfaces 12 at its parallel end sides 11 facing in opposite directions in order to ensure a continuous pneumatic connection right through all functional modules, or, respectively, pneumatic blocks placed in a row. For the mechanical or, respectively, sealed connection together plug, detent or screw connection means may be provided, which are not illustrated to simplify the drawings.

At the four remaining side walls of the basic pneumatic block 10 functional blocks are arranged, which are able to be placed in different manners, the number thereof being able to be chosen in a customized manner. On the front side a front block 13 is arranged provided with a display 14 and operating elements 15 in the form of keys. Such a front block 13 only needs to be arranged on one of the functional modules, the operation and the display being designed for all functional modules if desired.

On the opposite rear side a concatenation block 16 is arranged serving for the electrical concatenation of the functional modules. It possesses electrical plug connecting elements 17 on its side walls parallel to the end sides 11 of the basic pneumatic block 10, such elements 17 serving for plugging to corresponding basic pneumatic blocks 16 of the other functional modules. Accordingly a continuous conductor system is formed, which connects the functional modules together electrically. It may in this case be a question of field bus conductors and/or parallel conductors, any power supply necessary for the different functional modules being possible by way of such conductors. The concatenation blocks 16 are arranged on a holding ring 18, which serves to hold the entire compressed air system servicing device. Alternatively or in addition the functional modules or the basic pneumatic blocks may be directly concatenated together, by clamping, detent or screw means. In the case of field bus conductors the concatenation block 16 will comprise a corresponding bus station. The electronic elements of the concatenation block 16 are arranged on a printed circuit board 19, several printed circuit boards being provided if necessary. The printed circuit board 19 may comprise electronic control and/or diagnostic means and/or visualizing means for process parameters and process stages, which may serve for the control and for the diagnosis of their own functional modules or of all functional modules. The control and/or diagnostic means consequently do not have to be arranged in each concatenation block 16. The control and/or diagnostic means may for example be designed in the form of a microcontroller.

On the top side of the basic pneumatic block 10 a top functional block 20 is arranged and on the bottom side a bottom functional block 21 is arranged. In the case of these functional blocks it may be a question of switching on valves, safety valve, pressure regulators, filters, filter regulators, flow rate meters, distributors, adapters, driers or sensor means, as for instance pressure sensor means and filling level sensor means. In the working example the top functional block 20 possesses a printed circuit board 22, the bottom functional block 21 has two printed circuit boards 23 and 24 connected with each other and the front block 13 has one printed circuit board 25. The printed circuit boards 22 through 25 are electrically connected with the printed circuit board 19 of the concatenation block 16. For this purpose there are electrical plug connection elements 26 so that when plugging up the functional blocks the electrical connection are automatically produced. In principle lengths of cable or leads may be provided as connecting elements, which then must be inserted into the corresponding plug sockets. If the respectively selected and mounted functional blocks 20 and 21 do not have to fulfill any electrical functions, then the corresponding printed circuit boards 22 through 24 may naturally be omitted and any plug connecting elements 26 will not perform any function.

To the extent that the functional blocks 20 and 21 are pneumatic functional block or, respectively, functional blocks with pneumatic functions, the necessary pneumatic connections will be produced using diagrammatically indicated connecting lines 27 and interfaces. If for example the bottom functional block 21 is a valve or a filter, then the corresponding functional element will be connected between two connecting lines 27 on connection of the bottom functional block 21 with the basic pneumatic block 10, such lines extending in a downward direction. The two pneumatic interfaces 12 on the opposite end sides 11 are in this case respectively connected with one of such connecting line. If for example the top functional block 20 is a sensor block (as f. i. a pressure sensor block) or rate of flow meter block, then in this case as well the sensor will be placed in circuit with an upwardly extending connecting line 27 or between two upwardly extending connecting lines 27. The concatenation block 16 as well may for instance comprise a sensor and the connection will be correspondingly produced. If not pneumatic connection is required, then the outer ends of the connecting lines 27 present will be sealed off by the respective functional block or two connecting lines 27 will be connected with one another.

The electrical connection 28 between the front block 13 and the concatenation block 16 extends as a cable through the top functional block 20. It is naturally also possible to arrange such a connection to extend through the basic pneumatic block 10 if it has corresponding electrical interfaces and lines. Instead of a cable the electrical connection 28 may also be by way of fixed interfaces internally (for example in the top functional block 20) with the use of internal connecting lines or connecting elements.

The arrangement of the concatenation block 16, of the front block 13 and of the functional blocks 20 and 21 on the basic pneumatic block 10 involves the use of attachment means (not illustrated), such as plug, detent or screw connecting means. By interchanging the functional blocks it is possible to assign another function to the respective functional module. This may also take place in the mounted state of the compressed air system servicing device.

Instead of a single-piece concatenation block 16 in accordance with FIGS. 1 through 3 a two-piece concatenation block 29 in accordance with FIG. 2 may be substituted. It comprises an electrical power rail or bus element 30, which together with other similar electrical power buses of the other functional modules constitutes a continuous power bus, in which parallel lines 31 or serial bus lines extend. The lines 31 are in this case in the form of buses or rails. If an electronic functional block 32 is connected with the bus or rail element 30, for example using a detent or catch, by plugging or by screw means, the electrical contact will take place by spring contacts 33 of the electronic functional block 32, plug contact elements also being possible. In other respects the electronic functional block 32 is designed like the concatenation block 16. Identical or functionally equivalent components have the same reference numerals and are not described a second time over. In addition the printed circuit board 19 is provided with a pressure sensor 32, which on putting the electronic functional block 32 in position on the basic pneumatic block 10 is connected pneumatically with the same by way of a connection line 27.

The concatenation block 16 or the concatenation block 29 may be provided with automatic configuration recognition means. Such recognition may occur by way of the electrical plug connection elements 26, by which the type of the connected block may be sensed. On this basis the electronic circuitry in the concatenation block 16 may derive the overall functionality of the respectively configured functional module. Corresponding configuration settings may then be implemented automatically. This is more especially significant on substitution of blocks, since then the new configuration may be automatically detected so that the corresponding settings may be automatically effected.

The concatenation blocks 16 and, respectively, may exist in different designs and be selectively connected with the basic pneumatic blocks 10 of the respective compressed air system servicing device. Thus such a concatenation block 16 or, respectively, 29 may be in the form of a control component group for an individual functional module with an interface for commercially available analog and digital input and output signals. Furthermore such a control component group may possess different field bus interfaces for different types of bus, as for example ASinterface, Profibus and the like. In accordance with a further design the control component group may be provided with an interface for the internal, digital system networking means or also additionally be provided with an interface for an external bus.

The number of the blocks connected with the basic pneumatic block 10 is naturally not restricted to the number in the working example and in fact a smaller number of blocks may be connected. In the case of the design of the functional module as a filter module it is possible for example for only one bottom functional block 21 to be connected which comprises a filter element. However in addition a concatenation block 16 will be connected, even if there are no electrical functions to be performed in the respective functional module. This is however not mandatory. Moreover, electrical control and/or diagnostic means and/or visualizing means may be arranged (instead of in a concatenation block 16) in the top functional block 12 or in the bottom functional block 21, the respectively other block then being able to provide pneumatic functions.

1. A compressed air system servicing device comprising several functional modules able to be connected together in a row, wherein the modularly configured functional modules each include a uniform basic pneumatic block, which at two parallel outer walls possesses connection means for the production of the pneumatic connections on being placed in a row and at least two of the remaining outer walls of the basic pneumatic block possess interfaces for connection with functional blocks, at least one of the interfaces being designed to accept different functional blocks.

2. The compressed air system servicing device as set forth in claim 1, wherein the interfaces possess electrical and/or pneumatic connecting means, and more especially plug and/or screw connecting means.

3. The compressed air system servicing device as set forth in claim 1, wherein one of the functional blocks is an electrical concatenation block for electrical longitudinal concatenation of the functional modules.

4. The compressed air system servicing device as set forth in claim 3, wherein functional block designed in the form of a concatenation block possesses an interface, on at least one side not engaging the basic pneumatic block, for electrical connection with at least one functional block engaging the basic pneumatic block, the interface being more particularly designed in the form of an electrical plug or an electrical plug socket.

5. The compressed air system servicing device as set forth in claim 4, wherein the at least one functional block overlaps the basic pneumatic block and the functional block in the form of a concatenation block.

6. The compressed air system servicing device as set forth in claim 3 wherein a functional block, which is able to be engaged with the front side of the basic pneumatic block and is in the form of a front block, is electrically connected, by way of the basic pneumatic block or a functional block connected therewith, with the functional block in the form of a concatenation block.

7. The compressed air system servicing device as set forth in claim 6, wherein the functional block in the form of a front block is provided with a display device and/or operating elements.

8. The compressed air system servicing device as set forth in claim 3, wherein the functional block in the form of a concatenation block possesses electrical and/or mechanical decoding means for recognition of the connected functional blocks.

9. The compressed air system servicing device as set forth in claim 3, wherein the functional block in the form of a concatenation block includes electronic control and/or diagnostic means and/or visualizing means for process parameters and/or process stages.

10. The compressed air system servicing device as set forth in claim 3, wherein the functional block in the form of a concatenation block comprises a field bus interface.

11. The compressed air system servicing device as set forth in claim 3, wherein the functional block in the form of a concatenation block comprises a conductor supporting element and an electrical block able to be electrically coupled with same.

12. The compressed air system servicing device as set forth in claim 3, wherein the functional block in the form of a concatenation block comprises at least one printed circuit board which is able to be electrically connected with, and more particularly plugged to, printed circuit boards in functional blocks thereof which are able to be coupled.

13. The compressed air system servicing device as set forth in claim 1, wherein filter blocks and/or pressure regulating blocks and/or valve blocks and/or oiler blocks and/or sensor blocks and/or drier blocks and/or distributor blocks are designed as functional blocks able to be connected selectively with the basic pneumatic block.
